(19) United States
(12) Patent Application Publication
(10) Pub. No.: US 2011/0220654 A1
(43) Pub. Date: Sep. 15, 2011

(54) TRASH CAN WITH AN ADJUSTABLE DRAFT COMPARTMENT APPARATUS

(76) Inventors: Vincent Eugene Gray, Lynwood, IL (US); Shaunta Lesha Gardner, Lynwood, IL (US)

(21) Appl. No.: 13/045,597

(22) Filed: Mar. 11, 2011

Related U.S. Application Data
(60) Provisional application No. 61/312,923, filed on Mar. 11, 2010.

(51) Int. Cl. B65F 1/06; B65F 1/14

(52) U.S. Cl. 220/495.06

(57) ABSTRACT

The present invention relates generally to garbage cans. More particularly, the present invention relates to a trash can with an adjustable opening liner storage compartment with a primary purpose of acting as a storage compartment for trash can liner replacements (e.g., trash bags).

### CROSS REFERENCE TO RELATED APPLICATIONS

This application claims the benefit of U.S. Provisional Patent Application No. 61/312,823 Filed Mar. 11, 2010, the entire disclosure of which is incorporated herein by reference.

### FIELD OF THE INVENTION

The present invention relates generally to garbage cans. More particularly, the present invention relates to a trash can with an adjustable opening liner storage compartment with a primary purpose of acting as a storage compartment for trash can liner replacements (e.g., trash bags).

### BACKGROUND

Trash cans that include storage compartments for trash bags have always been a convenience sought after, but never fully achieved. Most trash bags are either stored in boxes, neatly folded or on rolls and are usually sold in quantities of 20 or more trash bags. Currently, these trash bags must be stored remotely from the trash can, which can be inconvenient when it comes time to replace a full trash bag in a trash can.

Other noted inventions have potential problems with leaking and seeping liquids or other hazardous or unclean materials from trash bags currently in use in a trash can. These seepages can ultimately affect the compartments that house un-used trash bags. This can lead to serious sanitation issues. Other inventions also require the incorporation of heavy apparatus attachments to operate, which can affect production cost as well as consumer response to convenience of product and cost of product.

U.S. Pat. No. 5,503,292, Gola—Relates to a trash receptacle having a bottom panel that forms a bag storage receptacle there below.

U.S. Pat. No. 5,628,424, Gola—Relates to a trash receptacle having a bottom panel that forms a bag storage receptacle there below.

U.S. Pat. No. 5,505,334, Triglia—Relates to a trash container liner dispensing system comprising a trash can having horizontal wall with a storage rod attached to the bottom of the wall. The wall forms a bag storage area there below and has a slot for delivering bags from the storage area to the trash container.

U.S. Pat. No. 5,458,259, Falk—Relates to a trash can with a liner dispenser including an upper open base having a horizontal cross sectional shape adapted to receive a trash receptacle. A hinge connects the base to the trash receptacle along a horizontal pivot axis extending along one side of the base.

U.S. Pat. No. 5,405,041, Van Brackle—Relates to a trash can with self dispensing trash liner pail located at bottom of trash can.

U.S. Pat. No. 5,322,180, Ker—Relates to a trash can with a separate container used as receiving slot that houses garbage bag rolls. This container is mounted in the lower cavities of the garbage can.

U.S. Pat. No. 6,568,555, LoCascio—Relates to a garbage receptacle with incorporated liner compartment including a container having an open upper end, closed end and surrounding side wall which allows for housing of box of garbage liners, whereby a single liner is fed through the open end of container.

U.S. Pat. No. 6,105,859, Stafford—Relates to a trash can having a trash bag storage compartment located at its bottom end, including a trash bag counter device that displays the number of bags remaining in a stack placed within the storage compartment.

None of the above references, nor anything in the prior art, has disclosed a single unit trash can with a adjustable draft compartment with a primary purpose of acting as a storage compartment for trash bags. Therefore, there is a need in the art for a trash can that can safely store and keep sanitary one or more replacement trash bags in an adjustable draft compartment. These and other features and advantages of the present invention will be explained and will become obvious to one skilled in the art through the summary of the invention that follows.

### SUMMARY OF THE INVENTION

Accordingly, the present invention provides a trash can with a convenient compartment that allows full usage of the trash can and trash bags, while conveniently storing un-used trash bags out of its obstruction.

Accordingly to an embodiment of the present invention, a trash can apparatus is provided, comprised of an adjustable opening liner storage compartment. In an exemplary embodiment, said adjustable opening liner storage compartment is sealed off from a main trash receptacle cavity.

Accordingly to an embodiment of the present invention, by sealing off said adjustable opening liner storage compartment, replacement trash bags are preserved in a sanitary setting, and may help to prevent the transmission or spread of bacteria, germs, viruses or other hazardous waste.

Accordingly to an embodiment of the present invention, an adjustable opening liner storage compartment may be further comprised of a convenient means of access. Said convenient means of access may be comprised of, for instance, a compartment door operable by a foot pedal. In an alternate embodiment, said convenient means of access may be a compartment door, operable by way of an easy to grip handle apparatus.

Accordingly to an embodiment of the present invention, a convenient means of access to an adjustable opening liner storage compartment may be further comprised of a sealing component. Said sealing component may be, for instance, a rubber sealing ring or an o-ring. Through the use of a sealing component, trash bags stored within the adjustable opening liner storage compartment may be further protected from substances or smells that may be spilled on or surround the trash can.

According to another embodiment of the present invention, manufacturing components of the trash can may be comprised of biodegradable materials, compostable materials, bio-renewable materials, bio-plastic materials or any combination thereof. In this manner, the trash can herein disclosed is environmentally safe and friendly.

According to another embodiment of the present invention, said adjustable opening liner storage compartment may be further comprised of a trash bag securing apparatus. For instance, a Velcro strap may be attached inside the adjustable opening liner storage compartment with the purpose of securing replacement trash bags within the adjustable opening line storage compartment.

The foregoing summary of the present invention with the preferred embodiments should not be construed to limit the scope of the invention. It should be understood and obvious to one skilled in the art that the embodiments of the invention thus described may be further modified without departing from the spirit and scope of the invention.

### BRIEF DESCRIPTION OF THE DRAWINGS

Referring to the drawings, wherein like reference numerals are used to designate like parts:

FIG. 1 is a perspective profile view of a preferred embodiment of the present invention with an open adjustable opening liner storage compartment;

FIG. 2 is a front profile view of a preferred embodiment of the present invention with a closed adjustable opening liner storage compartment;

FIG. 3 is a perspective profile view of an alternate embodiment of the present invention with an open adjustable opening liner storage compartment;

FIG. 4 is a front profile view of a preferred embodiment of the present invention with a closed adjustable opening liner storage compartment;

FIG. 5 is a perspective profile view of a preferred embodiment of the present invention with a closed adjustable opening liner storage compartment;

FIG. 6 is a front profile view of an alternate embodiment of the present invention with an open adjustable opening liner storage compartment;

FIG. 7 is a perspective profile view of an alternate embodiment of the present invention with an open adjustable opening liner storage compartment;

FIG. 8 is a front profile view of an alternate embodiment of the present invention with an open adjustable opening liner storage compartment;

### DETAILED SPECIFICATION

The present invention relates generally to garbage cans. More particularly, the present invention relates to a trash can with an adjustable opening liner storage compartment with a primary purpose of acting as a storage compartment for trash can liner replacements (e.g., trash bags).

According to an embodiment of the present invention, a trash can with an adjustable opening liner storage compartment is provided. The trash can is comprised of one or more exterior walls forming a main trash receptacle cavity within. Said main trash receptacle cavity is designed to receive a trash bag of an appropriate size. One of ordinary skill in the art would appreciate that various sizes and shapes of trash cans may be utilized with embodiments of the present invention, and embodiments of the present invention are contemplated for use with any size and shape trash can.

According to an embodiment of the present invention, a trash can as herein described may be further comprised of a sealing lid. Said sealing lid is configured to provide closure between said main trash receptacle cavity and an exterior environment. Sealing lids are frequently used to prevent the escape of odors, prevent access to the contents of said trash can, reduce the unsightliness of contents of said main trash receptacle cavity and reduce the likelihood of spilling said contents.

According to an embodiment of the present invention, received within at least one of said one or more exterior walls of said trash can is an adjustable opening liner storage compartment. Said adjustable opening liner storage compartment being comprised of one or more of a liner storage compartment, a convenient means of access, a trash bag securing apparatus and a sealing component.

The adjustable opening liner storage compartment is configured in such a way that the main trash receptacle cavity of the trash can is separated from said adjustable opening liner storage compartment. In this manner, waste materials are unable to spoil the replacement trash bags stored inside said adjustable opening liner storage compartment.

According to an embodiment of the present invention, the convenient means of access of said adjustable opening liner storage compartment may be one or more of a door operable by a foot pedal, a door operable by a easy grip handle or a sliding access panel. In some embodiments, the door or panel may open vertically, while in other embodiments the door may open horizontally. Alternatively, the door or panel may open in a combination of vertical and horizontal directions. Additionally, a door or panel may be configured to open in an outward direction. One of ordinary skill in the art would appreciate there are numerous ways a convenient means of access may be configured, and embodiments of the present invention are contemplated for use with any convenient means of access.

According to an embodiment of the present invention, a trash bag securing apparatus is attached to an inner portion of said adjustable opening liner storage compartment and is configured to receive and secure trash bags within said adjustable opening liner storage compartment. For instance, a Velcro strap may be attached inside the adjustable opening liner storage compartment with the purpose of securing replacement trash bags within the adjustable opening line storage compartment.

According to an embodiment of the present invention, a sealing component is attached to a component of said adjustable liner storage compartment and is configured to prevent the trash bags or other contents received within said adjustable liner storage component from being contaminated by external elements. Said sealing component may be attached to an outer rim of said adjustable liner storage component or said convenient means of access. No matter where the sealing component is attached, the seal is formed when said convenient means of access is in a closed position.

According to an alternate embodiment of the present invention, an adjustable liner storage compartment is capable of receiving within it other sanitation related items. For instance, said adjustable liner storage compartment may be configured to receive cans of spray disinfectants, deodorants, cleaning sponges, mops or other cleaning related items. For each sanitation item said adjustable liner storage compartment is configured to receive, there may also be an appropriate sanitation item securing apparatus. Sanitation item securing apparatuses may include, but are not limited to, hooks, Velcro straps, snap in holders or any combination thereof.

According to another embodiment of the present invention, manufacturing components of the trash can may be comprised of biodegradable materials, compostable materials, bio-renewable materials, bio-plastic materials or any combination thereof. In this manner, the trash can herein disclosed is environmentally safe and friendly.

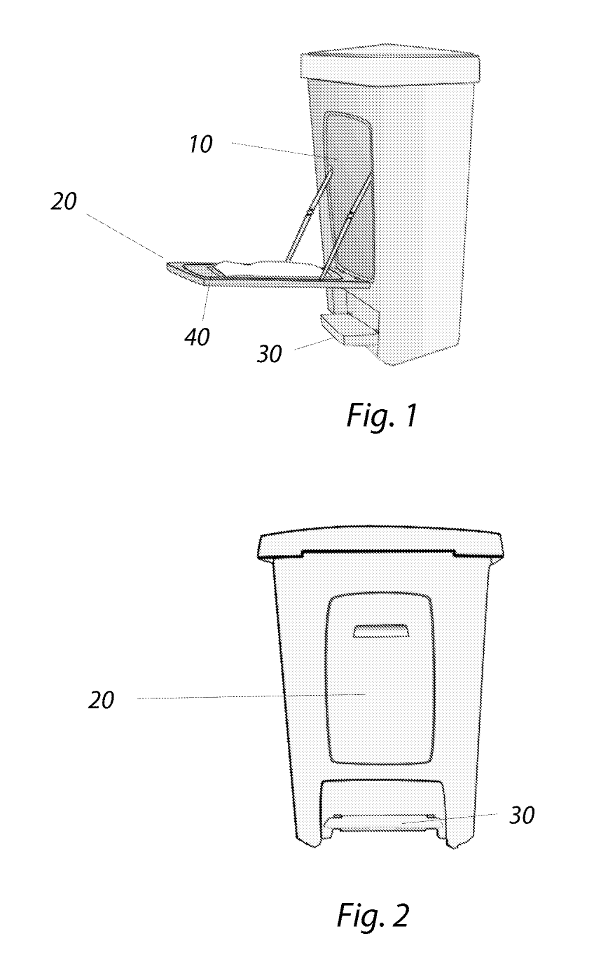

Turning now to FIG. 1, an exemplary embodiment of a trash can as described herein is disclosed. In this embodiment, a trash can is shown, comprised of an adjustable liner storage compartment 10, convenient means of access 20 which is operable via foot pedal 30. The trash can of FIG. 1 is further comprised of trash bag securing apparatus 40.

In the exemplary embodiment of FIG. 1, adjustable liner storage compartment 10 is accessible by way of convenient means of access 20 which may be moved between an open and a closed state via depressing foot pedal 30, preferably with one's foot. Additionally, trash bag securing apparatus 40 is secured to an interior wall of convenient means of access 20 and is capable of securing trash bags in such a manner as to not allow them to become dislodged upon opening of convenient means of access 20.

Turning now to FIG. 2, an exemplary embodiment of a trash can as described herein is disclosed. FIG. 2 represents a continuation of the embodiment shown in FIG. 1 and portrays what the exemplary trash can as shown in FIG. 1 appears like when convenient means of access 20 is in a closed position. When convenient means of access 20 is in a closed position, adjustable liner storage compartment 10 is inaccessible as is trash bag securing apparatus 40.

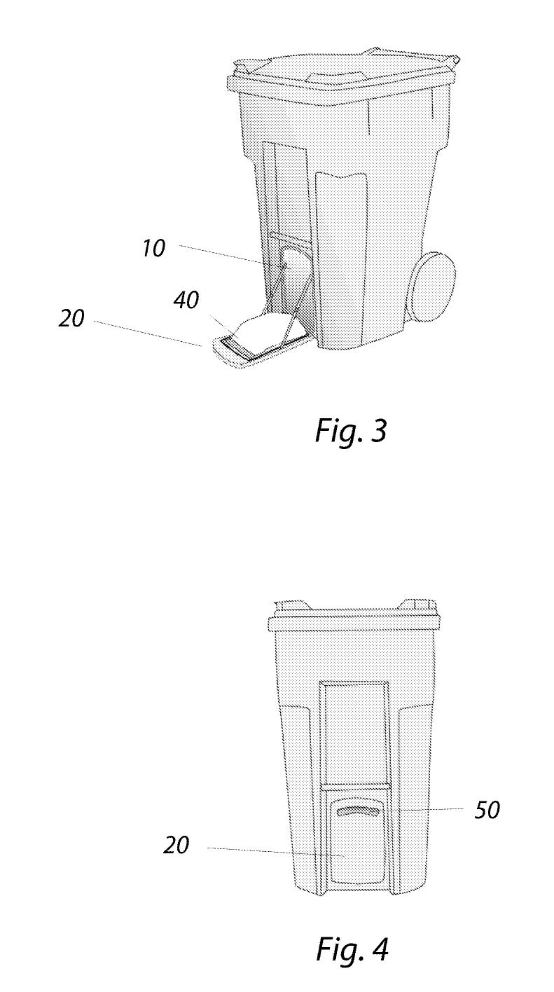

Turning now to FIG. 3, an alternative exemplary embodiment of a trash can as described herein is disclosed. In this embodiment, an industrial style trash can is shown, comprised of an adjustable liner storage compartment 10 and a convenient means of access 20. The trash can of FIG. 3 is further comprised of trash bag securing apparatus 40.

In the exemplary embodiment of FIG. 3, adjustable liner storage compartment 10 is accessible by way of convenient means of access 20. Additionally, trash bag securing apparatus 40 is secured to an interior wall of convenient means of access 20 and is capable of securing trash bags in such a manner as to not allow them to become dislodged upon opening of convenient means of access 20

Turning now to FIG. 4, an alternative exemplary embodiment of a trash can as described herein is disclosed. FIG. 4 represents a continuation of the embodiment shown in FIG. 3 and portrays what the exemplary trash can as shown in FIG. 3 appears like when convenient means of access 20 is in a closed position. When convenient means of access 20 is in a closed position, adjustable liner storage compartment 10 is inaccessible as is trash bag securing apparatus 40. Convenient means of access 20 in this embodiment is accessible by way of handle component 50.

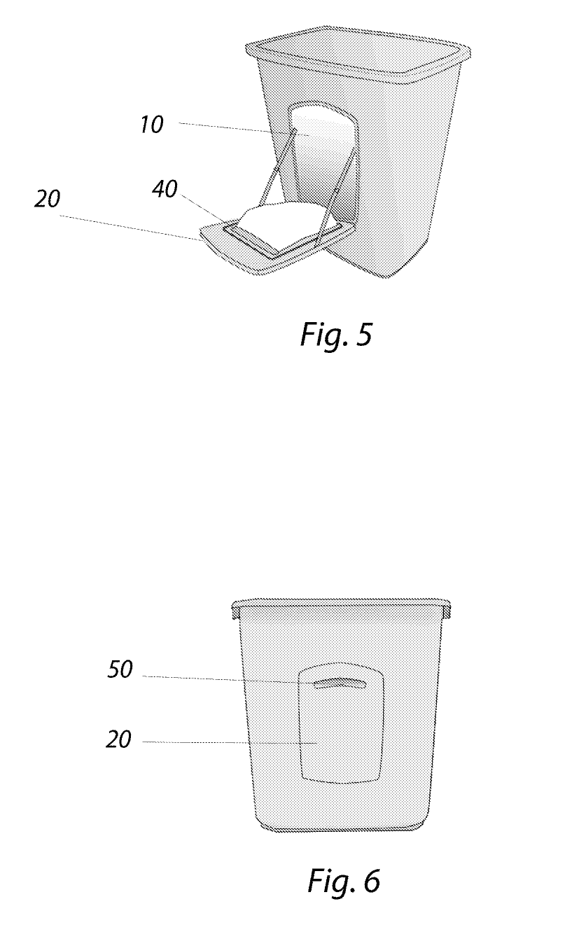

Turning now to FIG. 5, an alternative exemplary embodiment of a trash can as described herein is disclosed. In this embodiment, a trash can is shown, comprised of an adjustable liner storage compartment 10 and convenient means of access 20. The trash can of FIG. 1 is further comprised of trash bag securing apparatus 40.

In the exemplary embodiment of FIG. 5, adjustable liner storage compartment 10 is accessible by way of convenient means of access 20. Additionally, trash bag securing apparatus 40 is secured to an interior wall of convenient means of access 20 and is capable of securing trash bags in such a manner as to not allow them to become dislodged upon opening of convenient means of access 20

Turning now to FIG. 6, an alternative exemplary embodiment of a trash can as described herein is disclosed. FIG. 6 represents a continuation of the embodiment shown in FIG. 5 and portrays what the exemplary trash can as shown in FIG. 5 appears like when convenient means of access 20 is in a closed position. When convenient means of access 20 is in a closed position, adjustable liner storage compartment 10 is inaccessible as is trash bag securing apparatus 40. Convenient means of access 20 in this embodiment is accessible by way of handle component 50.

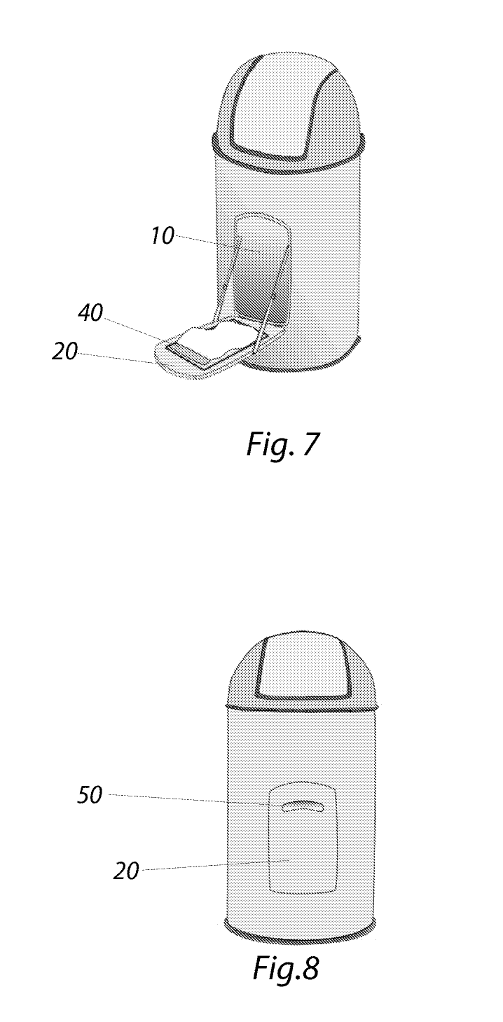

Turning now to FIG. 7, an alternative exemplary embodiment of a trash can as described herein is disclosed. In this embodiment, a trash can is shown, comprised of an adjustable liner storage compartment 10 and convenient means of access 20. The trash can of FIG. 1 is further comprised of trash bag securing apparatus 40.

In the exemplary embodiment of FIG. 7, adjustable liner storage compartment 10 is accessible by way of convenient means of access 20. Additionally, trash bag securing apparatus 40 is secured to an interior wall of convenient means of access 20 and is capable of securing trash bags in such a manner as to not allow them to become dislodged upon opening of convenient means of access 20

Turning now to FIG. 8, an alternative exemplary embodiment of a trash can as described herein is disclosed. FIG. 8 represents a continuation of the embodiment shown in FIG. 7 and portrays what the exemplary trash can as shown in FIG. 7 appears like when convenient means of access 20 is in a closed position. When convenient means of access 20 is in a closed position, adjustable liner storage compartment 10 is inaccessible as is trash bag securing apparatus 40. Convenient means of access 20 in this embodiment is accessible by way of handle component 50.

While multiple embodiments are disclosed, still other embodiments of the present invention will become apparent to those skilled in the art from this detailed description. The invention is capable of myriad modifications in various obvious aspects, all without departing from the spirit and scope of the present invention. Accordingly, the drawings and descriptions are to be regarded as illustrative in nature and not restrictive.

1. a trash can with an adjustable opening liner storage compartment, said trash can comprising:
one or more exterior walls,
wherein said one or more exterior walls form an interior main trash receptacle cavity; and
an adjustable liner storage compartment received within one of said one or more exterior walls,
wherein said adjustable liner storage compartment is further comprised of one or more storage compartment walls forming an interior liner storage area,
wherein said interior liner storage area is separated from said interior main trash receptacle cavity,
wherein said adjustable liner storage compartment is further comprised of a convenient means of access.

2. The trash can of claim 1, wherein said content adjustable liner storage compartment is further comprised of a sealing component.

3. The trash can of claim 1, wherein said content adjustable liner storage compartment is further comprised of a trash bag securing apparatus.

4. The trash can of claim 3, wherein said trash bag securing apparatus is comprised of a Velcro strap.

5. The trash can of claim 1, wherein said interior liner storage area is configured to receive trash bags.

6. The trash can of claim 1, wherein said interior liner storage area is configured to receive sanitation items.

7. The trash can of claim 1, wherein said convenient means of access is comprised of a door operable by a foot pedal.

8. The trash can of claim 1, wherein said convenient means of access is comprised of a panel operable by a foot pedal.

9. The trash can of claim 1, wherein said convenient means of access is comprised of a door operable by a handle.

10. The trash can of claim 1, wherein said convenient means of access is comprised of a panel operable by a handle.

11. The trash can of claim 1, wherein said convenient means of access is comprised of a panel operable by a sliding mechanism.
